(19) United States
(12) Patent Application Publication
(10) Pub. No.: US 2026/0288405 A1
(43) Pub. Date: Sep. 24, 2026

(54) Electronic Devices and Corresponding Methods for Presenting Videoconference Portions of Interest (POI) on a Companion Device

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Banglore (IN)

(21) Appl. No.: 19/084,305

(22) Filed: Mar. 19, 2025

(51) Int. Cl. G06F 3/14; G06V 20/40; G06V 40/16; G06V 40/20

(52) U.S. Cl. CPC G06F 3/1423; G06V 20/41; G06V 40/174; G06V 40/20

(57) ABSTRACT

A method for an electronic device involves detecting, with one or more processors during a videoconference when a user interface of the electronic device is operating in an immersive mode, that the electronic device is in communication both with at least one remote electronic device providing respective at least one videoconference feed and a companion electronic device. The one or more processors automatically select a portion of interest videoconference feed from the at least one videoconference feed. The one or more processors then redirect the portion of interest videoconference feed to the companion electronic device for presentation by the companion electronic device.

### BACKGROUND

### Technical Field

This disclosure relates generally to electronic devices, and more particularly to electronic devices with videoconferencing capabilities.

### Background Art

In recent years, the proliferation of virtual meetings has become a cornerstone of modern communication, particularly in the context of remote and hybrid work environments. As professionals increasingly rely on these platforms to collaborate across distances, the ability to effectively engage with participants during presentations has become increasingly important. However, when presenters operate in a mode where their screen is entirely occupied by the presentation content, they lose visibility of the participants' reactions. This lack of visual feedback can hinder the presenter's ability to gauge audience engagement and adjust their delivery, accordingly, potentially diminishing the effectiveness of the communication. It would be advantageous to have improved electronic devices and corresponding methods that allows presenters to understand audience reactions without interrupting their presentation flow, thereby enhancing the overall quality of virtual interactions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system in accordance with one or more embodiments of the disclosure.

FIG. 2 illustrates one or more method steps in accordance with one or more embodiments of the disclosure.

FIG. 3 illustrates an electronic device, and a companion electronic device engaged in a videoconference, with the electronic device operating in an immersive mode while a display of the companion electronic device presents a videoconference portion of interest in accordance with one or more embodiments of the disclosure.

FIG. 4 illustrates one or more method steps in accordance with one or more embodiments of the disclosure.

FIG. 5 illustrates one explanatory method in accordance with one or more embodiments of the disclosure.

FIG. 6 illustrates one explanatory electronic device in accordance with one or more embodiments of the disclosure.

FIG. 7 illustrates another explanatory electronic device in accordance with one or more embodiments of the disclosure.

FIG. 8 illustrates one or more instructions for a non-transitory computer-readable storage medium in accordance with one or more embodiments of the disclosure.

FIG. 9 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, with one or more processors during a videoconference when a user interface of the electronic device is operating in an immersive mode, that the electronic device is in communication both with at least one remote electronic device providing respective at least one videoconference feed and a companion electronic device, automatically selecting, by the one or more processors, a portion of interest videoconference feed from the at least one videoconference feed, and redirecting, by the one or more processors, the portion of interest videoconference feed to the companion electronic device for presentation by the companion electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to analyze a plurality of videoconference feeds received by the communication device from the plurality of remote electronic devices during the videoconference to select a portion of interest videoconference feed and, thereafter, cause the communication device to automatically redirect the portion of interest videoconference feed to the content presentation companion device for presentation when the user interface is operating in an immersive mode as described herein. The non-processor circuits may include, but are not limited to, a radio receiver, a radio transmitter, signal drivers, clock circuits, power source circuits, and user input devices.

As such, these functions may be interpreted as steps of a method to perform operating a user interface of the electronic device in an immersive mode during a videoconference, selecting a portion of interest videoconference feed as a function of predefined criteria including at least facial expressions, gestures, audible output, past pinning preferences, and/or participant hierarchy, and automatically redirecting the portion of interest videoconference feed to the content presentation companion device for presentation. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, there has been a proliferation of virtual meetings in recent years, with the videoconference becoming a cornerstone of modern communication. This is particularly true in the context of remote and hybrid work environments. Videoconferences allow professionals to collaborate across distances with ease and with a far smaller carbon footprint.

At the same time, embodiments of the disclosure contemplate that when presenters operate in a mode where their screen is entirely occupied by the presentation content, referred to herein as an “immersive mode” of operation, they lose visibility of the participants'reactions. This lack of visual feedback can hinder the presenter's ability to gauge audience engagement and adjust their delivery, accordingly, potentially diminishing the effectiveness of the communication.

Existing solutions to this problem often involve the use of extended monitors or secondary devices to display participant reactions. However, these solutions may not be feasible or convenient. Not all users have access to additional displays. Moreover, manually pinning or selecting relevant participant videos can be distracting and cumbersome. Furthermore, joining a call on another device to view audience reactions can lead to technical issues such as echo and is often considered unprofessional. These limitations highlight the need for a more integrated and seamless approach to maintaining audience engagement during immersive presentations.

Illustrating by example, consider an illustrative situation where Chris, a project manager, is presenting a significant project update remotely to his leader, John, and other important stakeholders who are physically present in a conference room. During the presentation, Chris operates in an immersive mode, where his screen is entirely occupied by the presentation content, leaving him unable to view the participants' reactions.

While operating in the immersive mode, and unbeknownst to Chris, John is not convinced by the direction of the presentation. As John's frustration turns into physical reactions, his dissatisfaction is a sentiment that becomes evident to everyone else in the room. After several minutes of Chris continuing without pause, John, visibly frustrated, interrupts to express his concerns. This incident highlights the importance of being able to “read the room” and adjust the presentation delivery in real-time based on audience feedback.

Following the meeting, Chris receives feedback from other leaders emphasizing the importance of maintaining awareness of participant reactions to enhance communication effectiveness. Determined to avoid similar situations in the future, Chris considers acquiring an extended display, although he remains uncertain if this setup will fully address the issue, as the setup requires pre-configuration before each call to ensure visibility of important participants.

This example underscores the challenges faced by presenters in immersive mode and the need for a solution that seamlessly surfaces portions of interest on a connected display, thereby enabling presenters to maintain audience engagement without disrupting their presentation flow. Advantageously, embodiments of the disclosure address these challenges by providing an innovative method and system for surfacing portions of interest (POI) from a videoconference on a connected companion device.

Advantageously, embodiments of the disclosure enable presenters to maintain focus on their presentation while simultaneously receiving real-time feedback from participants. By automatically detecting and displaying the most relevant participant reactions on a secondary device, the method allows presenters to “read the room” without interrupting their presentation flow. This approach not only enhances the quality of virtual interactions but also improves the overall user experience by leveraging existing device ecosystems to provide a more cohesive and efficient solution.

In one or more embodiments, one or more processors of an electronic device transfer a portions of interest (POI) videoconference feed to a companion electronic device when certain initial conditions are met. Illustrating by example, in one or more embodiments the initial conditions for implementing the solution of surfacing video call associated POI on a connected display involve several elements.

One requirement may include that there is an ongoing videoconference with multiple participants. Another requirement may be that a first device (Device A), which may be a desktop or laptop, is engaged in presenting content in an immersive mode. In one or more embodiments, when in the immersive mode of operation, the full screen of Device A will be occupied by the document or presentation being shared, thereby obscuring the view of remote participants' reactions.

Another requirement may be that there are one or more remote participants who have video being streamed to Device A, which may need to be communicatively connected to another device, Device B, which could be a smartphone or another electronic device distinct from an extension of Device A, such as a connected monitor. In one or more embodiments, Device B serves as the secondary display for presenting the detected POI, ensuring that the presenter can maintain focus on the presentation while simultaneously receiving real-time feedback from participants. This setup can then enable the seamless transfer of relevant videoconference feeds to Device B, thereby enhancing the presenter's ability to “read the room” without disrupting the presentation flow.

In one or more embodiments, a solution for surfacing video call associated POI on a connected display involves several steps to enhance the presenter's ability to engage with participants during immersive presentations. Initially, the system continuously monitors all active video streams from participants during the call. In one or more embodiments, if only one video stream is available, that stream is displayed on the secondary device.

When multiple video streams are present, in one or more embodiments the system analyzes these streams to detect the most important POI using criteria such as current activity, which includes facial expressions, gestures, or microphone input to identify the participant with the most activity. Additionally, in one or more embodiments the system considers past pinning preferences, prioritizing participants previously favored by the presenter, and ranks participants based on roles or designations, such as a VP or manager, to surface higher-ranking individuals if relevant.

In one or more embodiments, if none of these criteria are applicable, the system defaults to users with video turned ON. Once the POI is detected, the identified stream is automatically displayed on the secondary device, with continuous updates and adjustments based on real-time activity or shifts in meeting dynamics.

As an additional feature, in one or more embodiments an optional zoom feature is provided to enhance focus on a specific person identified as the POI. In cases where a clear POI cannot be detected or multiple participants are equally important, the system offers a manual override option, allowing the user to select or pin the desired video stream on the secondary device.

In one or more embodiments, a method in an electronic device pertains to a process implemented in an electronic device that enhances videoconferencing experiences by addressing the challenge of maintaining audience engagement during immersive presentations. In one or more embodiments, the method involves detecting, through one or more processors, when the electronic device is operating in an immersive mode during a videoconference. In one or more embodiments, this immersive mode is characterized by the user interface being fully occupied by presentation content, thereby obscuring the view of participant reactions.

In one or more embodiments, the electronic device is configured to communicate with at least one remote electronic device providing a videoconference feed and a companion electronic device. The method further includes automatically selecting a POI videoconference feed from the available videoconference feeds.

In one or more embodiments, this selection is based on predefined criteria such as participant activity, facial expressions, gestures, or past pinning preferences. Once the POI is identified, in one or more embodiments the method redirects the selected videoconference feed to the companion electronic device, allowing the presenter to view participant reactions on a secondary display without interrupting the presentation flow. This approach ensures that presenters can effectively “read the room” and adjust their delivery in real-time, thereby enhancing the overall quality of virtual interactions.

Advantageously, this arrangement allows presenters to maintain focus on their presentation while simultaneously receiving real-time feedback from participants. By automatically detecting and displaying the most relevant participant reactions on a secondary device, the method allows presenters to “read the room” without interrupting their presentation flow.

This approach not only enhances the quality of virtual interactions but also improves the overall user experience by leveraging existing device ecosystems to provide a more cohesive and efficient solution. The method's ability to automatically select and redirect the POI videoconference feed based on predefined criteria, such as participant activity, facial expressions, gestures, or past pinning preferences, ensures that presenters can effectively adjust their delivery in real-time, thereby enhancing the overall quality of virtual interactions.

In one or more embodiments, an electronic device comprises a communication device configured to interface with a plurality of remote electronic devices during a videoconference and a content presentation companion device. In one or more embodiments, the electronic device includes a user interface and one or more processors operable with the communication device and the user interface.

In one or more embodiments, the processors are configured to analyze multiple videoconference feeds received from the remote electronic devices to select a portion of interest videoconference feed. Subsequently, the processors cause the communication device to automatically redirect this selected portion of interest videoconference feed to the content presentation companion device for display when the user interface is operating in an immersive mode.

Advantageously, this configuration allows the presenter to maintain focus on the presentation content while simultaneously receiving real-time feedback from participants, thereby enhancing the overall quality of virtual interactions. By analyzing videoconference feeds and selecting the most relevant one based on predefined criteria, the system ensures that the presenter can effectively “read the room” without interrupting the presentation flow. This setup enhances the quality of virtual interactions by leveraging existing device ecosystems to provide a more cohesive and efficient solution. The ability to automatically redirect the POI feed to a companion device ensures that the presenter receives the most pertinent participant reactions, thereby improving the overall user experience during immersive presentations.

In one or more embodiments, a non-transitory computer-readable storage medium comprises instructions that, when executed by a processor of a media device, facilitate the operation of a user interface in an immersive mode during a videoconference. This immersive mode is characterized by the user interface being fully occupied by presentation content, thereby obscuring the view of participant reactions.

In one or more embodiments, the instructions enable the processor to select a portion of interest videoconference feed based on predefined criteria, which may include facial expressions, gestures, audible output, past pinning preferences, and participant hierarchy. Once the portion of interest is identified, the instructions cause the processor to automatically redirect this videoconference feed to a content presentation companion device for display. This redirection allows the presenter to maintain focus on the presentation while simultaneously receiving real-time feedback from participants, thereby enhancing the overall quality of virtual interactions.

In one or more embodiments, the instructions further allow for dynamic adjustment of the selection of the portion of interest feed in real-time, based on changes in activity or dynamics of the videoconference, ensuring that the most relevant participant reactions are continuously surfaced on the companion device. Additionally, the instructions ensure that the user interface presents content omitting depictions of videoconference participants when in the immersive mode, thereby maintaining the presenter's focus on the primary presentation content

This arrangement allows the electronic device to maintain the immersive mode, where the user interface is fully occupied by presentation content, while still providing the presenter with real-time feedback from participants. By selecting the POI based on criteria such as facial expressions, gestures, audible output, past pinning preferences, and participant hierarchy, the system ensures that the most relevant participant reactions are surfaced on the companion device. This capability enhances the presenter's ability to “read the room” without interrupting the presentation flow, thereby improving the effectiveness of communication during videoconferences.

Furthermore, the instructions facilitate a seamless integration of the companion device into the videoconferencing setup, leveraging existing device ecosystems to provide a more cohesive and efficient solution. This approach not only enhances the quality of virtual interactions but also reduces the cognitive load on the presenter by automating the selection and redirection of the POI feed, allowing the presenter to focus on delivering the presentation.

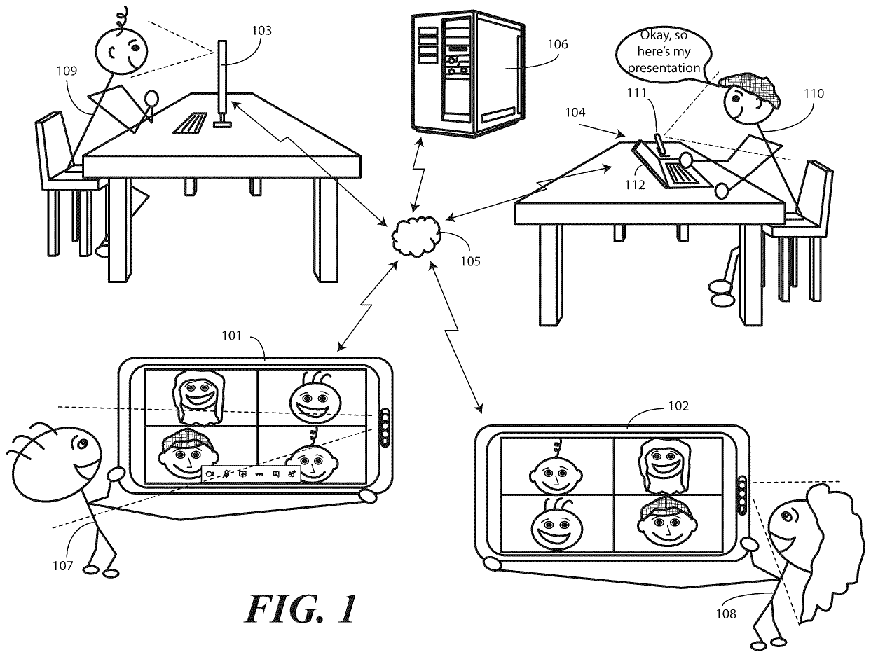

Turning now to FIG. 1, illustrated therein is one explanatory videoconference system in accordance with one or more embodiments of the disclosure. As shown, multiple participants 107,108,109,110 each employ their own respective conferencing system terminal device 101,102,103,104 to engage with the other participants via the videoconference.

In this illustrative embodiment, conferencing system terminal devices 101,102 are shown as smartphones, while conferencing system terminal device 103 is a desktop computer. Conferencing system terminal device 104 is a hybrid system where participant 110 watches the other participants 107,108,109 on a laptop computer 112 but uses the superior camera of his smartphone 111 to capture images of his face. In this situation, the smartphone 111 operates as a companion electronic device to the laptop computer 112.

However, conferencing system terminal devices suitable for use in the videoconference system can take other forms as well. For instance, tablet computers, notebook computers, audiovisual devices, mobile phones, smart watches, or other devices can be used by participants to engage in the videoconference as well. Other examples of conferencing system terminal devices will be obvious to those of ordinary skill in the art having the benefit of this disclosure.

As shown in FIG. 1, each conferencing system terminal device 101,102,103,104 is engaged in wired or wireless communication with each other across a network 105, one example of which is the Internet via the World Wide Web. It should be noted that the network 105 could be a public, private, local area, wide area, or other type of network across which wired or wireless electronic communications can be exchanged.

In this illustrative embodiment, each conferencing system terminal device 101,102,103,104 is also in communication with a video conferencing system server complex 106 across the network 105. In one or more embodiments, the video conferencing system server complex 106 includes components such as a web server, a database server, an audio server, and optionally a video server (the video server may be omitted for audio only conferencing systems) that are operable to facilitate videoconferences between the various conferencing system terminal devices 101,102,103,104 of the videoconference system.

These components of the video conferencing system server complex 106 can be combined on the same server. Alternatively, these components can be distributed on any number of servers to increase load handling capacity beyond that of a single server, and so forth. Other configurations for the video conferencing system server complex 106 will be obvious to those of ordinary skill in the art having the benefit of this disclosure.

In one or more embodiments, the video conferencing system server complex 106 performs functions such as maintaining a schedule of videoconferences, maintaining lists of participants, as well as allowing each participant's conferencing system terminal device to engage with the videoconference, and so forth. In one or more embodiments, the video conferencing system server complex 106 also facilitates the transmission of audio and video content during the occurrence of the videoconference.

In one or more embodiments, the video conferencing system server complex 106 functions as an intermediary device to facilitate sharing of audio and/or video content and/or data between the various conferencing system terminal devices 101,102,103,104. For example, as can be seen on the displays of conferencing system terminal devices 101,102, in this example each participant 107,108,109,110 can see each other participant engaged in the videoconference.

In the illustrative example of FIG. 1, the participants 107,108,109,110 are engaged in the videoconference. Since the participants 107,108,109,110 are all engaged in a videoconference, each can see conference content in the form of a combined video feed from each other participant 107,108,109,110 presented on the display of each conferencing system terminal device 101,102,103,104, as well as a video feed of themselves. Each participant 107,108,109,110 can hear an audio feed from each other participant 107,108,109,110 as well.

In this illustrative example, Mac, who is participant 110, is in the midst of an important videoconference. Indeed, Mac stands as the presenter, ready to unveil his meticulously crafted strategy to rejuvenate the company's faltering sales of squirrel feeders. The market had been unforgiving since Chuck and Henry introduced their innovative feeders, causing a significant decline in Mac's company's product line.

Despite Chuck and Henry's domination of the recent market, Mac is undeterred. This is true because Mac is armed with a comprehensive plan, he dubbed the “leave no squirrels unfed” initiative. This plan is designed to not only reclaim market share but also to set a new standard in the industry.

As he prepared to present, Mac was acutely aware of the stakes. His boss, Buster, participant 107, is watching closely. Mac knows that impressing Buster with his vision and execution is of great importance, as the outcome could determine the future trajectory of his career. With determination and a touch of nervous excitement, Mac launches into his presentation, eager to demonstrate the potential of his strategy and win Buster's approval.

To wow and amuse Buster, Mac transitions his laptop computer 112 into the immersive mode of operation. This transfer is an important step for delivering his “leave no squirrels unfed” presentation with grace and confidence.

This immersive mode allows Mac to fully engage with his presentation content by occupying the entire screen, thereby minimizing distractions and enabling a focused delivery. By eliminating peripheral visual clutter, Mac can concentrate solely on the presentation material, ensuring that his strategic plan to rejuvenate the company's sales of squirrel feeders is communicated effectively.

This mode is particularly significant as it allows Mac to maintain a seamless flow of information, capturing the attention of his audience, including his boss Buster, and other important stakeholders. The immersive mode thus plays a significant role in enhancing the clarity and impact of Mac's presentation, fostering a professional and polished delivery that is crucial for persuading his audience and achieving his presentation objectives.

In the context of FIG. 1, when Mac transitions his laptop computer 112 into the immersive mode, the entire display becomes occupied by the presentation content, specifically the “leave no squirrels unfed” initiative. This immersive mode is designed to minimize distractions by allowing the presenter to focus solely on the presentation material.

However, this mode also results in the loss of visibility of the videoconference participants, including Buster, who plays an important role in the meeting. As a result, Mac is unable to observe Buster's reactions, expressions, or any non-verbal cues that might indicate his level of engagement or agreement with the initiative being discussed. This lack of visual feedback can hinder Mac's ability to adjust his presentation in real-time based on Buster's reactions, potentially affecting the effectiveness of the communication and the overall outcome of the meeting.

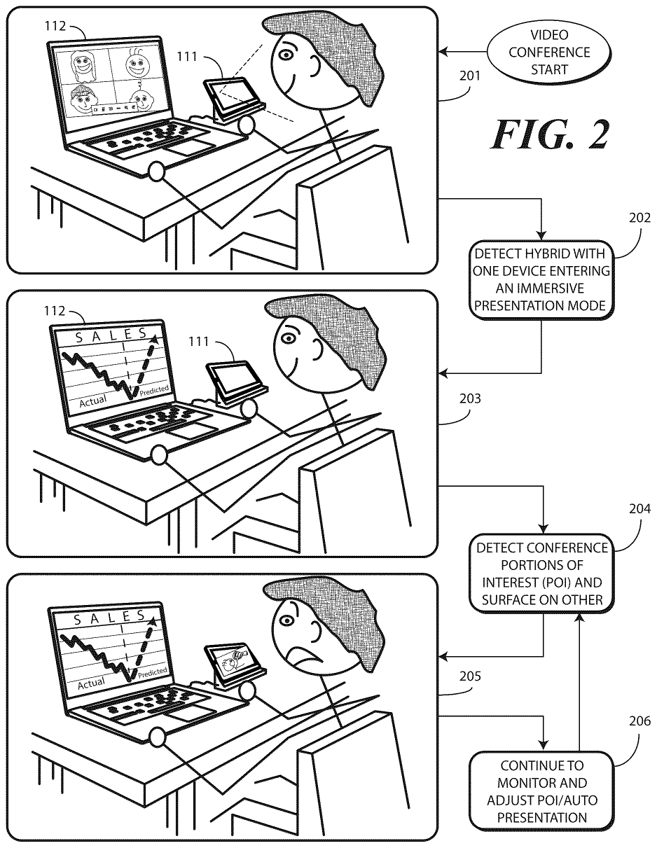

Advantageously, embodiments of the disclosure provide a solution to this dilemma. Fortunately, Mac's laptop computer 112 is configured in accordance with one or more embodiments of the disclosure. Accordingly, it includes one or more processors that are configured to detect, during a videoconference when a user interface of the electronic device is operating in an immersive mode, that the electronic device is in communication both with at least one remote electronic device providing respective at least one videoconference feed and a companion electronic device. In one or more embodiments, the one or more processors then automatically select a portion of interest videoconference feed from the at least one videoconference feed. In one or more embodiments, the one or more processors redirect the portion of interest videoconference feed to the companion electronic device for presentation by the companion electronic device. Turning now to FIG. 2, illustrated therein are one or more method steps showing how this occurs.

At step 201 of FIG. 2, Mac's laptop computer 112 and smartphone 111 are depicted as operating in a hybrid environment, where the videoconference feed is actively presented on the display of the laptop computer 112. In this configuration, the smartphone 111, equipped with a higher resolution image capture device, is utilized to capture images of Mac, thereby enhancing the quality of his video feed to other participants.

Notably, at this stage, the laptop computer 112 is not engaged in the immersive mode, which allows Mac to view the videoconference feeds of all other participants directly on the laptop's display. This setup ensures that Mac can maintain visual contact with the participants, enabling him to effectively gauge their reactions and engagement levels during the videoconference, thus facilitating a more interactive and responsive communication experience.

At step 202, one or more processors of the laptop computer 112 detect that a communication device in communication with both a plurality of remote electronic devices during a videoconference and a content presentation companion device. As shown at step 201, the plurality of remote electronic devices is streaming the plurality of videoconference feeds Mac sees on the display of the laptop computer 112. The smartphone 111 serves as the content presentation companion device.

At step 203 of FIG. 2, Mac transitions his laptop computer 112 into the immersive mode to present the first slide of his “leave no squirrels unfed” primary campaign. This immersive mode is designed to enhance focus by allowing the presentation content to occupy substantially all of the display, thereby preventing any of the videoconference feeds from being visible, as was the case at step 201.

As Mac unveils the first slide, he introduces a humorous marketing campaign centered around the concept of “Squirrel Feastival,” a playful twist on traditional festivals, where each backyard becomes a haven for squirrels. The campaign features quirky slogans like “Nuts About You” and “Feast, You Furry Friends,” accompanied by vibrant visuals of squirrels enjoying an abundance of feeders.

Mac passionately explains that this innovative approach will captivate the target audience, turning the current steeply downward sales trajectory on its head. He envisions this campaign not only revitalizing the brand but also propelling the company to unprecedented heights, with projections of millions in profits as consumers eagerly embrace the whimsical charm of the “Squirrel Feastival.”

At step 204, during the videoconference when the user interface of the laptop computer 112 is operating in the immersive mode, one or more processors of the laptop computer 112 detect that the laptop computer is in communication both with at least one remote electronic device providing respective at least one videoconference feed and a companion electronic device, which is the smartphone 111. At step 204, the one or more processors automatically select a portion of interest videoconference feed from the videoconference feeds being received.

At step 204, the one or more processors automatically redirect the portion of interest videoconference feed to the smartphone 111 for presentation by the smartphone 111. In other embodiments, step 204 comprises exiting the immersive mode.

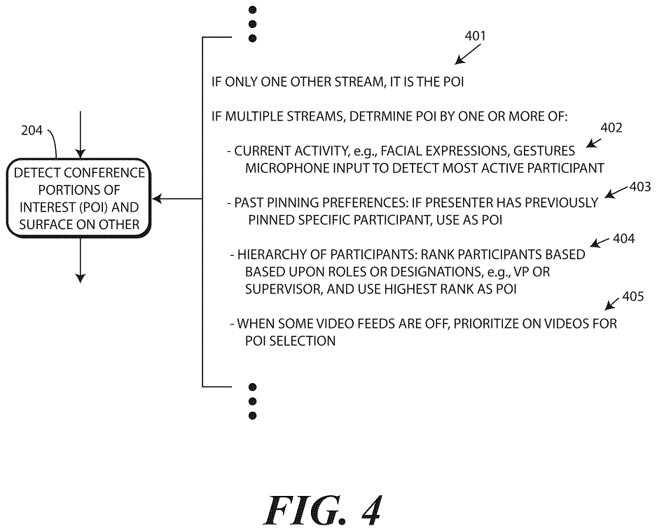

The one or more processors can select the portion of interest videoconference feed in a variety of ways. Turning briefly to FIG. 4, illustrated therein are various techniques for selecting the portion of interest videoconference feed. Others will be obvious to those of ordinary skill in the art having the benefit of this disclosure.

In one or more embodiments, such as when the at least one remote electronic device comprises one or more remote electronic devices having image capture devices turned ON and one or more other remote electronic devices having other image capture devices turned OFF 405, the portion of interest videoconference feed is selected at step 204 from the one or more remote electronic devices having the image capture devices turned ON. In the context of videoconferencing, selecting a portion of interest videoconference feed from devices with cameras turned ON is beneficial because it ensures that the presenter receives real-time visual feedback from participants, which is important for gauging audience engagement and reactions.

When cameras are turned ON, the system can analyze visual cues such as facial expressions and gestures, providing a more comprehensive understanding of participant responses. This capability allows the presenter to adjust their delivery dynamically, enhancing the effectiveness of communication. On the other hand, feeds from devices with cameras turned OFF lack visual data, limiting the ability to assess participant engagement accurately. By prioritizing feeds with active video, the system can surface the most relevant participant reactions, thereby improving the overall quality of the virtual interaction and ensuring that the presenter can effectively “read the room” without interrupting the presentation flow.

In other embodiments, the selecting the portion of interest videoconference feed comprises selecting a videoconference feed from a remote electronic device associated with a previous videoconference feed 403 redirected to the companion electronic device manually by an authorized user of the electronic device. Selecting a videoconference feed from a participant that a user had previously, in other videoconferences, manually moved to a companion electronic device as a portion of interest can be highly beneficial for several reasons.

This approach leverages the user's historical preferences and interactions, thereby enhancing the relevance and personalization of the videoconference experience. By prioritizing feeds that the user has previously deemed important enough to manually redirect, the system can automatically surface participants who are likely to be of significant interest to the user, such as important stakeholders, frequent collaborators, or individuals whose feedback is particularly valued. This not only streamlines the process of identifying important participants but also reduces the cognitive load on the user, allowing them to focus more on the content of the presentation rather than managing the videoconference interface. Furthermore, this method can improve the efficiency of the videoconference by ensuring that the most pertinent participant reactions and inputs are readily accessible, thereby facilitating more dynamic and responsive interactions.

In still other embodiments, step 204 can comprise determining, by the one or more processors, a hierarchy 404 of authorized users of each remote electronic device. Where this occurs, the selecting the portion of interest videoconference feed comprises selecting an authorized user having a highest rank within the hierarchy 404. Thus, if Mac's boss is a vice president, while the others in the room are simply managers, step 204 may select Mac's boss as having a highest rank within the hierarchy 404.

In one or more embodiments, step 204 comprises analyzing, by the one or more processors, each videoconference feed from each remote electronic device for at least one depicted activity 402. In one or more embodiments, the selecting the portion of interest videoconference feed comprises selecting a videoconference feed depicting more of the at least one depicted activity 402 than other videoconference feed.

Illustrating by example, the selection of a portion of interest in a videoconference feed can be based on depicted activities such as facial expressions, gestures, and audible sounds. For instance, facial expressions can be a powerful indicator of a participant's engagement or reaction to the presentation content. A participant displaying a smile or nodding may indicate agreement or understanding, while a frown or puzzled look could suggest confusion or disagreement. By prioritizing feeds with such expressions, the presenter can quickly identify and address areas of concern or capitalize on positive feedback.

Similarly, gestures such as hand-raising or waving can signal a participant's desire to contribute or ask a question, making it beneficial to highlight these feeds to facilitate interactive discussions. Audible sounds, including laughter or verbal affirmations, can also provide immediate feedback on the presentation's impact, allowing the presenter to adjust their delivery in real-time. Utilizing these depicted activities to select the portion of interest in the videoconference feed ensures that the presenter remains attuned to the audience's reactions, thereby enhancing the overall effectiveness and engagement of the virtual meeting.

In some embodiments, such as when there is only one other participant 401, that other participant can become the portion of interest videoconference feed by default. Other criteria for selecting the portion of interest videoconference feed will be obvious to those of ordinary skill in the art having the benefit of this disclosure.

Turning now back to FIG. 2, step 203 of FIG. 2, Mac enthusiastically unveils his “Squirrel Feastival” campaign, a whimsical initiative designed to rejuvenate the company's sales of squirrel feeders. However, Buster, Mac's boss, is less than impressed.

As the presentation progresses, Buster's interest wanes, and he turns away from the screen, opting instead to indulge in Block and Brownie's world-famous chicken, a delicacy renowned for its irresistible flavor. This surprising turn of events is detected as the depicted activity at step 206, where the system's processors continue to identify Buster's culinary diversion as a significant activity. As a result, the video conference feed capturing Buster's enthusiastic consumption of the chicken is automatically redirected to Mac's smartphone 111.

In another illustrative scenario, consider Amit, a project lead, who is presenting a significant quarterly performance review to his supervisor, Senior Vice President Johnson. As Amit delves into the intricacies of the project metrics, he notices that Johnson, instead of maintaining eye contact or taking notes, begins to frequently glance at his mobile device. This behavior, much like Buster's preoccupation with eating chicken, serves as a subtle yet clear indication of waning interest in the presentation.

Such non-verbal cues are important for presenters to recognize, as they may signal a need to adjust the presentation strategy to re-engage the audience. While these examples highlight specific instances of disengagement, those skilled in the art having the benefit of this disclosure will find it apparent that various other behaviors, such as checking a watch, doodling, or engaging in side conversations, can similarly indicate a decline in audience attention. These observations underscore the importance of being attuned to audience reactions to maintain effective communication during presentations.

Returning to the example at hand, this redirection, as shown at step 205, allows Mac to witness firsthand Buster's disengagement from the presentation, leaving him momentarily horrified. Yet, Mac's quick wit and adaptability come to the fore as he realizes the need for a strategic pivot.

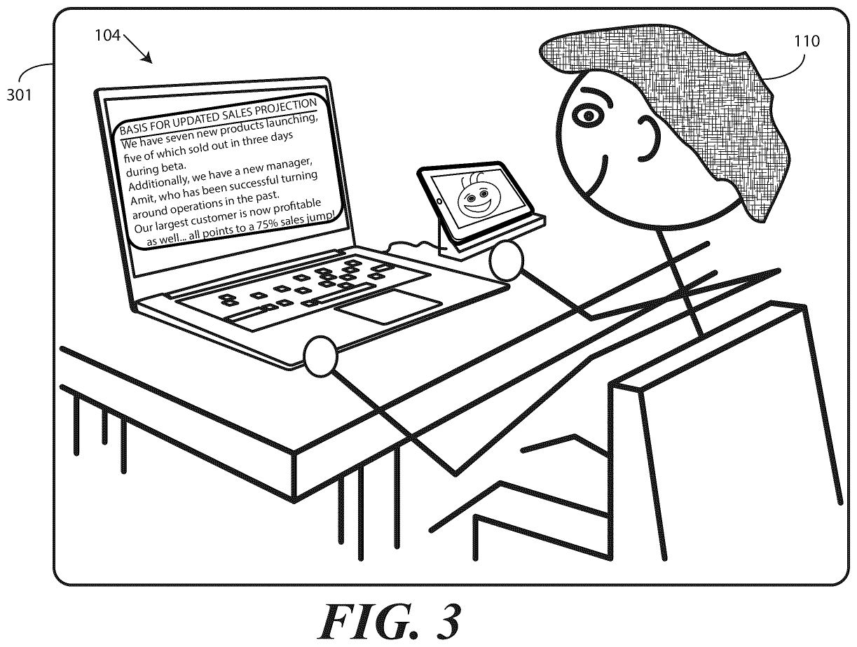

Drawing inspiration from Buster's evident preference for the chicken, Mac swiftly shifts his presentation focus, perhaps suggesting a partnership with Block and Brownie to create a “Squirrel and Chicken Feastival,” cleverly integrating the two beloved elements. This humorous yet insightful adjustment not only recaptures Buster's attention but also showcases Mac's ability to think on his feet, turning a potentially disastrous situation into an opportunity for innovation. The result is shown in FIG. 3.

Turning now to FIG. 3, at step 301 of FIG. 3 Mac adds his “Squirrel and Chicken Feastival” campaign by announcing the launch of seven innovative squirrel products, each accompanied by an associated marketing campaign. The new products include the “Nutty Navigator,” a GPS-enabled feeder that guides squirrels to the most desirable nuts, the “Squirrel Spa,” offering a mini oasis for relaxation, the “Acorn Arcade,” featuring games to entertain squirrels, the “Tail Twister,” a playful exercise wheel the “Furry Feast,” a gourmet nut selection, the “Squirrel Sanctuary,” a cozy nesting box, and the “Chatter Chew,” a toy that mimics squirrel sounds. Each product is marketed with quirky slogans and engaging visuals, such as “Navigate Your Way to Nut Nirvana” for the Nutty Navigator and “Relax, Rejuvenate, Repeat” for the Squirrel Spa.

To spearhead this ambitious campaign, Mac has hired Amit, a new manager renowned for his “half-day” work ethic, which humorously translates to working from 7 AM to 7 PM, seven days a week. Amit brings a wealth of experience from his tenure at squirrel product competitors, where he successfully boosted sales even in markets dominated by Chuck and Henry.

Furthermore, the company's most significant customer, Kermit's Squirrel Emporium, has recently turned profitable and is poised to become a prominent buyer of Squirrel Feastival gear. This impressive turnaround has so captivated Buster that he has set aside his Block and Brownie's chicken, planning to reward Mac with a raise, the title of employee of the month, and a promotion to director of marketing.

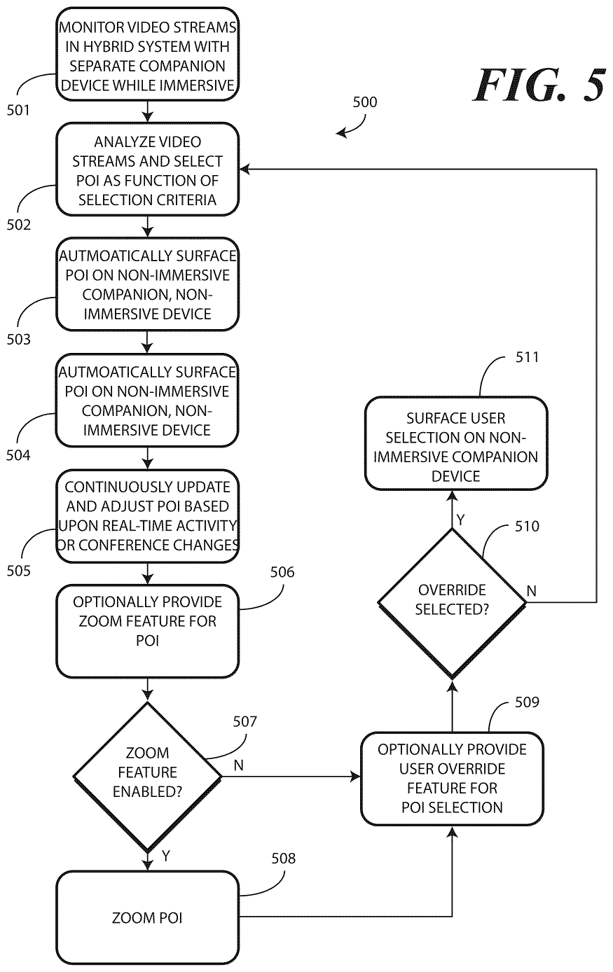

Turning now to FIG. 5, illustrated therein is one explanatory method 500 in accordance with one or more embodiments of the disclosure. At step 501 of method 500 depicted in FIG. 5, the electronic device engaged in a videoconference operates in conjunction with a companion electronic device to monitor videoconference streams in a hybrid setting. In one or more embodiments, this monitoring process involves several techniques to determine whether the electronic device enters an immersive mode.

One technique includes analyzing the display output of the electronic device to detect when the presentation content occupies the entire screen, thereby indicating the transition into immersive mode. Another technique involves monitoring user interface interactions, such as keyboard shortcuts or mouse clicks, that are typically associated with entering full-screen presentation modes.

Additionally, the system can utilize network traffic analysis to identify changes in data flow patterns that correspond with immersive mode activation. Each of these techniques offers distinct advantages: display output analysis provides a direct indication of screen usage, user interface monitoring captures user intent, and network traffic analysis offers a non-intrusive method to detect mode changes.

By employing these techniques, the system ensures accurate and efficient detection of immersive mode, thereby facilitating the seamless redirection of portions of interest to the companion electronic device. In one or more embodiments, step 501 of the method 500 of FIG. 5 comprises detecting, with one or more processors during a videoconference when a user interface of the electronic device is operating in an immersive mode, that the electronic device is in communication both with at least one remote electronic device providing respective at least one videoconference feed and a companion electronic device.

In step 502 of FIG. 5, the method 500 involves analyzing, by one or more processors, each videoconference feed from each remote electronic device for at least one depicted activity. This analysis can be performed using multiple techniques, each offering distinct advantages.

One technique involves facial recognition algorithms to detect and interpret facial expressions, providing insights into participant engagement and emotional responses. This method is advantageous as it allows for real-time sentiment analysis, enabling the presenter to adjust their delivery based on audience reactions.

Another technique utilizes gesture recognition, which identifies hand movements or body language, offering a broader understanding of participant interactions beyond facial expressions. This approach is beneficial in capturing non-verbal cues that may indicate a participant's desire to contribute or ask questions.

Additionally, audio analysis can be employed to detect changes in voice tone or volume, which can signify a participant's level of interest or urgency. This technique is particularly useful in identifying active speakers or those who may require attention. By employing these techniques, the system ensures a comprehensive analysis of participant activities, enhancing the presenter's ability to understand the audience and maintain effective communication during immersive presentations.

In step 503 of FIG. 5, the method involves the automatic selection, by one or more processors of a portion of interest videoconference feed from the available videoconference feeds. The selection can be made in a variety of ways. Many were described above with reference to FIG. 4. Still others will be obvious to those of ordinary skill in the art having the benefit of this disclosure. In one or more embodiments, this selection process is based on predefined criteria, which may include participant activity levels, such as facial expressions, gestures, or audible output, as well as past pinning preferences or participant hierarchy.

Once the POI videoconference feed is identified, in one or more embodiments the processors are configured at step 503 to redirect this feed to a companion electronic device for presentation. This redirection allows the presenter to maintain focus on the primary presentation content while simultaneously receiving real-time feedback from participants, thereby enhancing the overall quality of virtual interactions. The seamless transfer of the POI feed to the companion device ensures that the presenter can effectively “read the room” without interrupting the presentation flow, thus improving communication effectiveness during immersive presentations.

In step 504 of FIG. 5, prior to the automatic redirection of the portion of interest videoconference feed to the user interface of the companion electronic device, the system optionally presents a prompt to the user. Where presented, this prompt serves as an intermediary step, allowing the user to confirm or modify the automatic redirection process.

In some embodiments, the prompt not only confirms the redirection of the pre-selected POI feed but also provides the user with the option to select a different videoconference feed for redirection. This feature enhances user control and flexibility, enabling the user to tailor the videoconference experience according to their preferences or situational needs.

By facilitating user selection, the system ensures that the most relevant participant reactions are displayed on the companion device, thereby optimizing the presenter's ability to engage with the audience effectively. This approach not only maintains the integrity of the immersive presentation mode but also allows for dynamic adjustments based on real-time user input, ensuring a seamless and responsive videoconferencing experience.

Step 505 of FIG. 5 involves a dynamic process where the system continually updates and adjusts the selection of the portion of interest (POI) videoconference feed that is automatically redirected to the companion electronic device in real time during the videoconference. This process is facilitated by one or more processors that monitor various criteria, such as participant activity levels, facial expressions, gestures, and audible outputs, to determine which participant is currently most relevant to the presenter's needs.

As the videoconference progresses, the system employs machine learning algorithms to analyze these criteria, allowing the system to adapt to changes in participant engagement or meeting dynamics. For instance, if a participant who was previously less active becomes more animated or begins speaking, the system can seamlessly switch the POI feed to this participant, ensuring that the presenter receives the most pertinent feedback without manual intervention. This real-time adjustment capability enhances the presenter's ability to “read the room” and respond to audience cues effectively, thereby improving the overall quality of the virtual interaction.

Step 506 provides an optional feature that allows the user to magnify portions of the portion of interest videoconference feed after the feed has been automatically redirected to the companion electronic device. This feature is particularly useful when a specific person is identified as being depicted in the POI videoconference feed.

In such cases, step 506 offers the user the ability to zoom in on the individual's videoconference feed on the companion electronic device, thereby enhancing focus on that participant. This zoom functionality is activated in response to user input received by the user interface of the electronic device, allowing the presenter to gain a clearer and more detailed view of the participant's expressions and gestures. This capability ensures that the presenter can maintain a high level of engagement with important participants, thereby improving the overall effectiveness of the communication during the videoconference.

In the context of the method 500 of FIG. 5, decision step 507 involves determining whether user input has been received to magnify the portion of interest videoconference feed. This step plays a role in enhancing the presenter's ability to focus on specific participants during a videoconference.

In one or more embodiments, the system continuously monitors for user interactions with the companion electronic device, such as touch gestures or input commands, that indicate a desire to zoom in on the POI feed. Upon detecting such input, the system proceeds to step 508, where the POI videoconference feed is magnified.

In one or more embodiments. this magnification is executed by the one or more processors, which adjust the display settings of the companion device to enlarge the selected video feed, thereby providing the presenter with a clearer and more detailed view of the participant's expressions and gestures. This feature allows for improved engagement and interaction during the presentation, ensuring that the presenter can effectively “read the room” and respond to audience cues in real-time.

Step 509 of FIG. 5 optionally provides a user override feature that allows the user to select their own portion of interest videoconference feed, offering flexibility and control over the videoconference experience. This feature can be implemented in several ways, each with distinct advantages.

One approach is to present a list of available videoconference feeds on the companion device, enabling the user to manually select the desired feed through a simple interface, such as a dropdown menu or a grid of video thumbnails. This method provides the advantage of giving users direct control over which participant's feed they wish to prioritize, ensuring that they can focus on the most relevant content according to their specific needs or preferences.

Another implementation could involve a drag-and-drop interface, where users can rearrange video feeds on the companion device by dragging the desired feed into a designated POI area. This interactive method enhances user engagement and allows for quick adjustments during dynamic meetings.

Additionally, voice command integration could be employed, allowing users to verbally instruct the system to switch the POI feed, which is particularly advantageous in hands-free environments or when the user is multitasking. Each of these implementations enhances the user experience by providing customizable options to tailor the videoconference setup to individual preferences, thereby improving the overall effectiveness of communication.

Decision 510 determines whether the user override of step 509 has been invoked. This decision allows the user to manually select a portion of interest videoconference feed, thereby providing flexibility and control over the videoconference experience.

If the user override is invoked, step 511 is executed, where the selection made by the user is surfaced on the companion electronic device. This ensures that the user's preferences are prioritized, allowing for a customized viewing experience that aligns with the user's specific needs or interests.

Conversely, if no user override is invoked, the method 500 returns to step 502. In step 502, the system resumes its analysis of the plurality of videoconference feeds received by the communication device from the plurality of remote electronic devices. This analysis is conducted to automatically select a POI videoconference feed based on predefined criteria, ensuring that the most relevant participant reactions are continuously surfaced on the companion device without manual intervention.

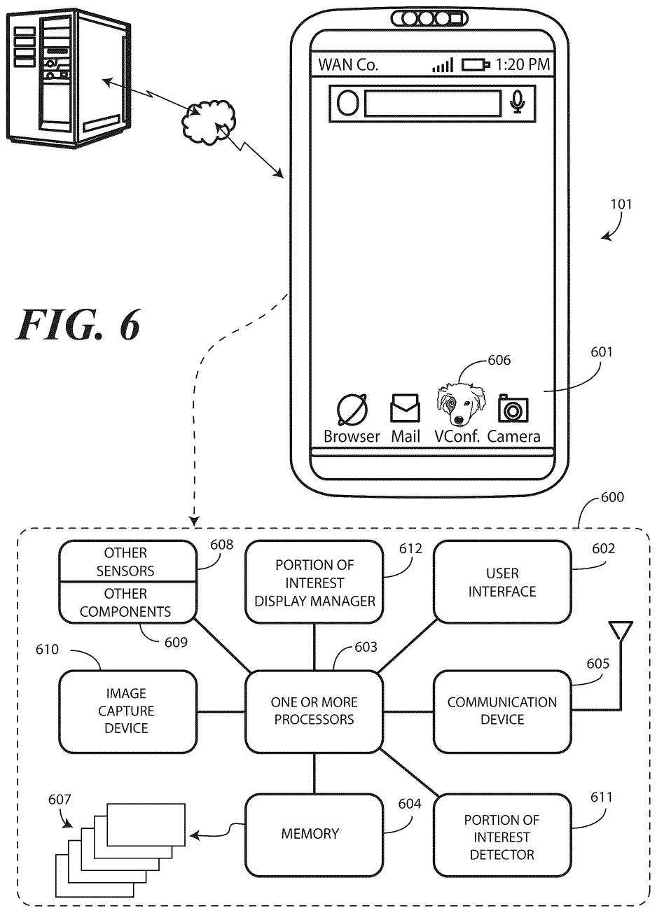

Turning now to FIG. 6, illustrated therein is one explanatory conferencing system terminal device 101. The conferencing system terminal device 101 of FIG. 6 is a portable electronic device. For illustrative purposes, the conferencing system terminal device 101 is shown as a smartphone.

However, the conferencing system terminal device 101 could be any number of other devices as well, including tablet computers, desktop computers, notebook computers, and so forth. Still other types of conferencing system terminal devices can be configured in accordance with one or more embodiments of the disclosure as will be readily appreciated by those of ordinary skill in the art having the benefit of this disclosure.

This illustrative conferencing system terminal device 101 includes a display 601, which may optionally be touch-sensitive. In one embodiment where the display 601 is touch-sensitive, the display 601 can serve as a primary user interface 602 of the conferencing system terminal device 101. Users can deliver user input to the display 601 of such an embodiment by delivering touch input from a finger, stylus, or other objects disposed proximately with the display 601.

In one embodiment, the display 601 is configured as an active-matrix organic light emitting diode (AMOLED) display. However, it should be noted that other types of displays, including liquid crystal displays, would be obvious to those of ordinary skill in the art having the benefit of this disclosure. Where the conferencing system terminal device 101 is configured with a keyboard and/or mouse, such as when the conferencing system terminal device 101 is configured as a computer, the keyboard and/or mouse can serve as the primary user interface 602.

A block diagram schematic 600 of the conferencing system terminal device 101 is also shown in FIG. 6. The block diagram schematic 600 can be configured as a printed circuit board assembly disposed within the device housing of the conferencing system terminal device 101. Various components can be electrically coupled together by conductors, or a bus disposed along one or more printed circuit boards.

In one or more embodiments, the conferencing system terminal device 101 includes one or more processors 603. In one embodiment, the one or more processors 603 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the conferencing system terminal device 101. Each of the application processor and the auxiliary processor(s) can be configured to process and execute executable software code to perform the various functions of the conferencing system terminal device 101. A storage device, such as memory 604, can optionally store the executable software code used by the one or more processors 603 during operation.

The conferencing system terminal device 101 also includes a communication device 605 that can be configured for wired or wireless communication with one or more other devices or networks. The networks can include a wide area network, a local area network, and/or personal area network. The communication device 605 may also utilize wireless technology for communication, such as, but are not limited to, peer-to-peer or ad hoc communications such as HomeRF, Bluetooth and IEEE 802.11, and other forms of wireless communication such as infrared technology. The communication device 605 can include wireless communication circuitry, one of a receiver, a transmitter, or transceiver, and one or more antennas.

In one embodiment, the one or more processors 603 can be responsible for performing the primary functions of the conferencing system terminal device 101. For example, in one embodiment the one or more processors 603 comprise one or more circuits operable with one or more user interface devices, which can include the display 601, to engage in videoconferences by transmitting, receiving, and presenting images, video, or other presentation information.

The executable software code used by the one or more processors 603, including that associated with a videoconference application 606, can be configured as one or more modules 607 that are operable with the one or more processors 603. Such modules 607 can store instructions, control algorithms, logic steps, and so forth.

In one embodiment, the one or more processors 603 are responsible for running the operating system environment of the conferencing system terminal device 101. The operating system environment can include a kernel and one or more drivers, and an application service layer, and an application layer. The operating system environment can be configured as executable code operating on one or more processors or control circuits of the conferencing system terminal device 101.

The application layer can be responsible for executing application service modules. The application service modules may support one or more applications or “apps,” such as the videoconference application 606. The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 603 may generate commands or execute control operations based upon user input received at the user interface 602. Moreover, the one or more processors 603 may process the received information alone or in combination with other data, such as the information stored in the memory 604.

The conferencing system terminal device 101 can include one or more sensors 608. The one or more sensors 608 may include a microphone, camera, any of the sensors described above, an earpiece speaker, and/or a second loudspeaker. The one or more other sensors 608 may also include touch actuator selection sensors, proximity sensors, a touch pad sensor, a touch screen sensor, a capacitive touch sensor, and one or more switches.

Touch sensors may be used to indicate whether any of the user actuation targets present on the display 601, including the user actuation targets presented in a prompt facilitating the commencement of analyzing a plurality of videoconference feeds received by the communication device from the plurality of remote electronic devices during the videoconference to select a portion of interest videoconference feed and, thereafter, causing the communication device to automatically redirect the portion of interest videoconference feed to the content presentation companion device for presentation when the user interface is operating in an immersive mode as described above, are being actuated. The other sensors 608 can also include audio sensors and video sensors (such as a camera).

Other components 609 operable with the one or more processors 603 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 609 can also include an image processor. The image processor can include hardware, executable code, and image processing executable code in one embodiment. The image processor can include, stored in memory 604, basic image models, trained image models, or other modules that are used by the image processor to determine whether images captured by the imager include portions depicting obscured portions of a subject depicted in those images. In one embodiment, the image processor can include an object recognition engine.

Regardless of the specific implementation utilized in the various embodiments, the image processor can access various image models to determine whether a person is engaged in an activity during analyzing a plurality of videoconference feeds received by the communication device from the plurality of remote electronic devices during the videoconference to select a portion of interest videoconference feed and, thereafter, causing the communication device 605 to automatically redirect the portion of interest videoconference feed to the content presentation companion device for presentation when the user interface is operating in an immersive mode that may, for example, trigger the delivery of a video overlay in one or more embodiments.

To capture video during a videoconference, in one or more embodiments the conferencing system terminal device 101 includes an image capture device 610 or another imager. The conferencing system terminal device 101 can optionally include a depth imager as well.

In one embodiment, the image capture device 610 comprises a two-dimensional imager configured to receive at least one image of a person within an environment of the conferencing system terminal device 101. In one embodiment, the image capture device 610 comprises a two-dimensional RGB imager. In another embodiment, the image capture device 610 comprises an infrared imager. Other types of imagers suitable for use as the image capture device 610 of the conferencing system terminal device 101 will be obvious to those of ordinary skill in the art having the benefit of this disclosure.

In one or more embodiments, the conferencing system terminal device 101 includes a portion of interest display manager 612. In one or more embodiments, the portion of interest display manager 612 can detect receipt of user input at the user interface 602 defining a request to analyze a plurality of videoconference feeds received by the communication device from the plurality of remote electronic devices during the videoconference to select a portion of interest videoconference feed and, thereafter, cause the communication device to automatically redirect the portion of interest videoconference feed to the content presentation companion device for presentation when the user interface is operating in an immersive mode. In one or more embodiments, in response to the request, the portion of interest display manager 612 can present a prompt allowing a selection of a subset of the plurality of remote electronic devices for inclusion in the analysis while the videoconferencing application 606 is engaged in a videoconference.

The portion of interest display manager 612 can further transmit a request to the subset of the plurality of remote electronic devices inviting them to participate in the analysis. The portion of interest display manager 612 can establish the analysis during the videoconference without disconnecting the videoconferencing application 606 from the videoconference. The portion of interest display manager 612 can allow the communication device 605 to transmit video signals from the conferencing system terminal device 101 to the subset of the plurality of remote electronic devices and can preclude the communication device 605 from transmitting the video signals to remote electronic device of the plurality of remote electronic devices omitted from inclusion in the subset of the plurality of remote electronic devices. The portion of interest display manager 612 can perform other operations described above with reference to FIGS. 2-8 as well.

In one or more embodiments, the conferencing system terminal device 101 also includes a portion of interest detector 611 as well. In one or more embodiments, the portion of interest detector 611 can analyze the video feeds as described above with reference to FIGS. 1-5.

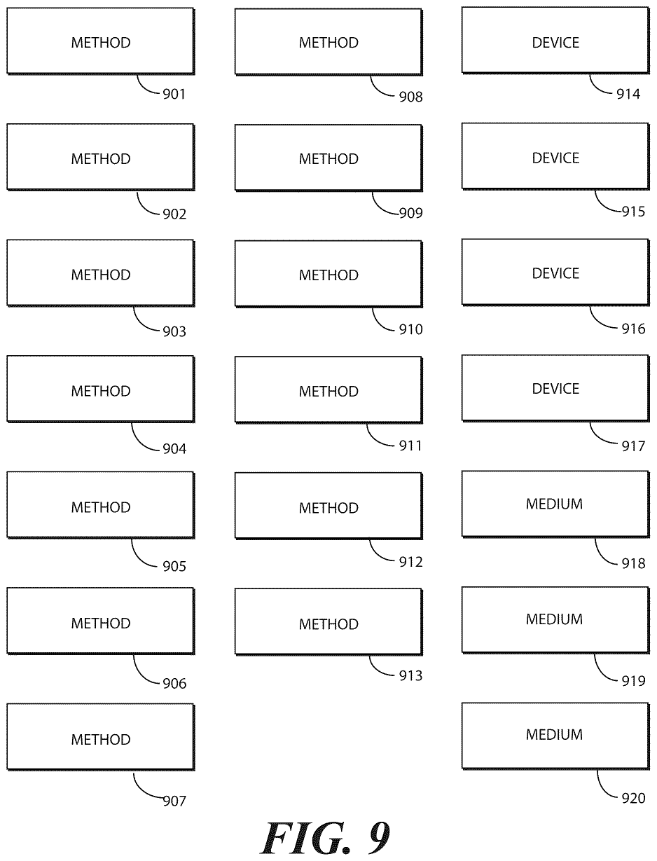

Illustrating by example, the portion of interest detector 611 can include a generative artificial intelligence manager that analyzes video feeds from real time images, in the form of animations, from training information, video libraries, image libraries, video captured during past videoconferences, or from user defined information. The portion of interest detector 611 can employ an artificial neural network or other similar technology that detects user activities during analyzing a plurality of videoconference feeds received by the communication device from the plurality of remote electronic devices during the videoconference to select a portion of interest videoconference feed and, thereafter, causing the communication device to automatically redirect the portion of interest videoconference feed to the content presentation companion device for presentation when the user interface is operating in an immersive mode as shown above in FIG. 9.

In one or more embodiments, the portion of interest display manager 612 and/or the portion of interest detector 611 can be operable with the one or more processors 603. In some embodiments, the one or more processors 603 can control the portion of interest display manager 612 and/or the portion of interest detector 611. In other embodiments, the portion of interest display manager 612 and/or the portion of interest detector 611 can operate independently from the one or more sensors 608. The portion of interest display manager 612 and/or the portion of interest detector 611 can receive data from the various sensors. In one or more embodiments, the one or more processors 603 are configured to perform the operations of the portion of interest display manager 612 and/or the portion of interest detector 611.

In one or more embodiments, the portion of interest detector 611 automatically analyzes video feeds in a video feed of a videoconference. In one or more embodiments, the portion of interest detector 611 automatically analyzes the video feeds in place of images depicting the analysis participants during the videoconference. In one or more embodiments, the portion of interest detector 611 automatically inserts the video feeds prior to the communication device 605 transmitting the images to other conferencing system terminal devices participating in the videoconference. Thereafter, the communication device 605 can transmit the (now) video feeds to conceal participation in the analysis. In other embodiments, the portion of interest detector 611 inserts the video feeds into images received from other conferencing system terminal devices participating in the videoconference.

The portion of interest display manager 612 and/or the portion of interest detector 611 can be operable with the various sensors 608. The portion of interest display manager 612 and/or the portion of interest detector 611 can detect, infer, capture, and otherwise determine engagement in analyzing a plurality of videoconference feeds received by the communication device from the plurality of remote electronic devices during the videoconference to select a portion of interest videoconference feed.

Thereafter, the portion of interest display manager 612 and/or the portion of interest detector 611 can cause the communication device to automatically redirect the portion of interest videoconference feed to the content presentation companion device for presentation when the user interface is operating in an immersive mode. In one or more embodiments, the portion of interest display manager 612 and/or the portion of interest detector 611 perform activities in analyzing a plurality of videoconference feeds received by the communication device from the plurality of remote electronic devices during the videoconference to select a portion of interest videoconference feed. Thereafter, the portion of interest display manager 612 and/or the portion of interest detector 611 cause the communication device to automatically redirect the portion of interest videoconference feed to the content presentation companion device for presentation when the user interface is operating in an immersive mode.

Examples of selection criteria include hysterical laughter, excessive crying, sleeping, mentioning names of videoconference participants not engaged in the videoconference, or other criteria that will be obvious to those of ordinary skill in the art having the benefit of this disclosure. Illustrating by example, other criteria can comprise cursing, leaving the field of view of the image capture device 610, generally talking smack, and so forth within an environment about the conferencing system terminal device 101.

For example, where included one embodiment of the portion of interest display manager 612 determines assessed contexts and frameworks using adjustable algorithms of context assessment employing information, data, and events. These assessments may be learned through repetitive data analysis. These assessments can be used to obtain additional contextual information when the contextual information changes in one or more embodiments. The portion of interest display manager 612 can comprise an artificial neural network or other similar technology in one or more embodiments.

In one or more embodiments, the one or more processors 603 are configured to analyze a plurality of videoconference feeds received by the communication device from the plurality of remote electronic devices during the videoconference to select a portion of interest videoconference feed. In one or more embodiments, thereafter, the one or more processors 603 cause the communication device 605 to automatically redirect the portion of interest videoconference feed to the content presentation companion device for presentation when the user interface is operating in an immersive mode.

In one or more embodiments, the one or more processors 603 are configured to select the portion of interest videoconference feed based upon at least one criterion. In one or more embodiments, the at least one criterion comprises one or more of facial expressions, gestures, microphone input, past pinning preferences, participant hierarchy, and/or combinations thereof.

In one or more embodiments, the immersive mode comprises the user interface presenting content other than the plurality of videoconference feeds received from the plurality of remote electronic devices. In one or more embodiments, the one or more processors 603 employ machine learning algorithms to select the portion of interest videoconference feed using real-time sentiment analysis of participant expressions to determine which participant is most expressive. In one or more embodiments, selection of the portion of interest videoconference feed is dynamically adjusted during the videoconference when the participant who is most expressive changes. In one or more embodiments.

It is to be understood that FIG. 6 is provided for illustrative purposes only and for illustrating components of one conferencing system terminal device 101 in accordance with embodiments of the disclosure and is not intended to be a complete schematic diagram of the various components required for a conferencing system terminal device. Therefore, other conferencing system terminal devices in accordance with embodiments of the disclosure may include various other components not shown in FIG. 6 or may include a combination of two or more components or a division of a particular component into two or more separate components and still be within the scope of the present disclosure.

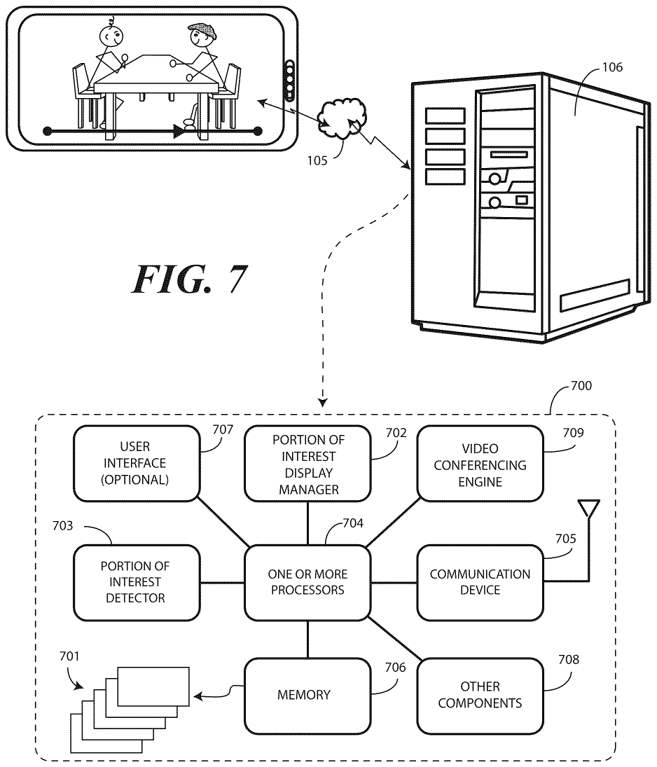

Turning now to FIG. 7, illustrated therein is one explanatory video conferencing system server complex 106 configured in accordance with one or more embodiments of the disclosure. An illustrative schematic block diagram 700 is also shown in FIG. 7.

As with the block diagram schematic (600) of FIG. 6, it is to be understood that the schematic block diagram 700 of FIG. 7 is provided for illustrative purposes only and for illustrating components of one explanatory conferencing system server complex 106 configured in accordance with one or more embodiments of the disclosure. Accordingly, the components shown in either FIG. 6 or FIG. 7 are not intended to be complete schematic diagrams of the various components required for a particular device, as other devices configured in accordance with embodiments of the disclosure may include various other components not shown in FIG. 6 or FIG. 7. Alternatively, other server complexes or conferencing system terminal devices configured in accordance with embodiments of the disclosure or may include a combination of two or more components or a division of a particular component into two or more separate components and still be within the scope of the present disclosure.

In one or more embodiments the conferencing system server complex 106 can be configured with performing processor-intensive methods, operations, steps, functions, or procedures associated with the presentation, actuation, and management of dynamic, automatic, and real time analyzing a plurality of videoconference feeds received by the communication device from the plurality of remote electronic devices during the videoconference to select a portion of interest videoconference feed and, thereafter, causing the communication device to automatically redirect the portion of interest videoconference feed to the content presentation companion device for presentation when the user interface is operating in an immersive mode.

Illustrating by example, the conferencing system server complex 106 can be configured to receive one or more images 701 in a video feed of a videoconference across a network 105. A portion of interest display manager 703 can then, in response to user input received at a conferencing system terminal device in communication with the conferencing system server complex 106 analyze a plurality of videoconference feeds received by the communication device from the plurality of remote electronic devices during the videoconference to select a portion of interest videoconference feed. Thereafter, the conferencing system server complex 106 can cause the communication device to automatically redirect the portion of interest videoconference feed to the content presentation companion device for presentation when the user interface is operating in an immersive mode during a videoconference hosted by the videoconferencing engine 709.

A portion of interest detector 702 can even transmit a video overlay for an authorized user of a conferencing system terminal device engaged in a communication device to remote electronic device of the plurality of remote electronic devices engaged in the videoconference hosted by the videoconferencing engine 709 that are omitted from inclusion in the remote electronic device to conceal participation of the authorized user in analyzing a plurality of videoconference feeds received by the communication device from the plurality of remote electronic devices during the videoconference.

In one or more embodiments, the conferencing system server complex 106 includes one or more memory devices 706, and one or more user interface devices 707, e.g., a display, a keyboard, a mouse, audio input devices, audio output devices, and alternate visual output devices. The conferencing system server complex 106 also includes a communication device 705. These components 708 can be operatively coupled together such that, for example, the one or more processors 704 are operable with the one or more memory devices 706, the one or more user interface devices 707, the communication device 705, and/or other components 708 of the conferencing system server complex 106 in one or more embodiments.

The one or more processors 704 can include a microprocessor, a group of processing components, one or more ASICs, programmable logic, or other type of processing device. The one or more processors 704 can be configured to process and execute executable software code to perform the various functions of the conferencing system server complex 106.

The one or more memory devices 706 can optionally store the executable software code used by the one or more processors 704 in carrying out the operations of the videoconference system. The one or more memory devices 706 may include either or both of static and dynamic memory components. The one or more memory devices 706 can store both embedded software code and user data.

In one or more embodiments, the one or more processors 704 can define one or more process engines. For instance, the software code stored within the one or more memory devices 706 can embody program instructions and methods to operate the various functions of the conferencing system server complex 106, and also to execute software or firmware applications and modules such as the portion of interest display manager 703 and/or the portion of interest detector 702.

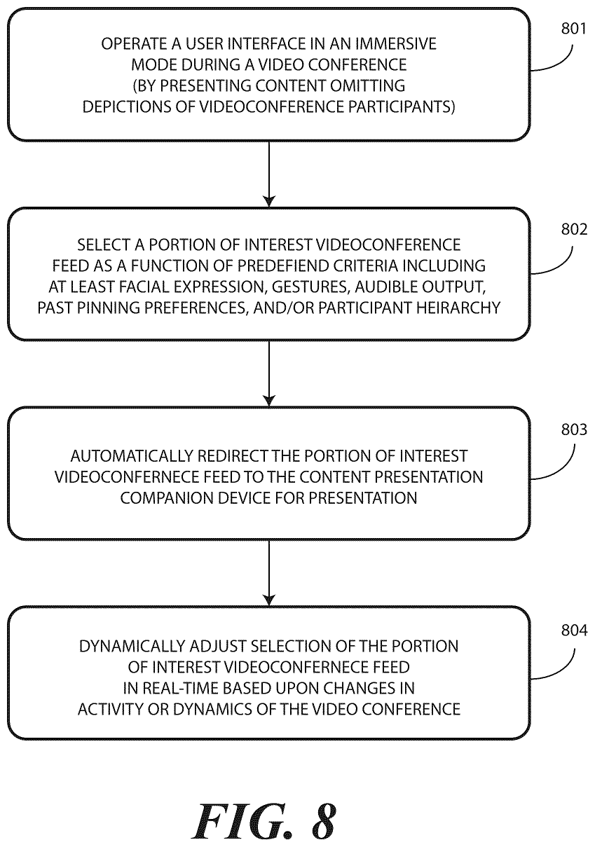

Turning now to FIG. 8, illustrated therein are instructions for a non-transitory computer-readable storage medium that, when executed by a processor of a media device, cause the processor to perform operations. In one or more embodiments, these operations comprise a first operation 801 where the processor operates a user interface of the electronic device in an immersive mode during a videoconference. In one or more embodiments, this first operation 801 comprise causing the user interface to present content omitting depictions of videoconference participants when in the immersive mode.

In one or more embodiments, a second operation 802 comprises selecting a portion of interest videoconference feed as a function of predefined criteria. In one or more embodiments, the predefined criterion comprises at least facial expressions, gestures, audible output, past pinning preferences, and/or participant hierarchy. In one or more embodiments, a third operation 803 comprises automatically redirecting the portion of interest videoconference feed to the content presentation companion device for presentation. In one or more embodiments, a fourth operation 804 comprises dynamically adjusting selection of the portion of interest feed in real-time based on changes in activity or dynamics of the videoconference.

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises detecting, with one or more processors during a videoconference when a user interface of the electronic device is operating in an immersive mode, that the electronic device is in communication both with at least one remote electronic device providing respective at least one videoconference feed and a companion electronic device. At 901, the method comprises automatically selecting, by the one or more processors, a portion of interest videoconference feed from the at least one videoconference feed. At 901, the method comprises redirecting, by the one or more processors, the portion of interest videoconference feed to the companion electronic device for presentation by the companion electronic device.

At 902, the at least one remote electronic device of 901 comprises one or more remote electronic devices having image capture devices turned ON and one or more other remote electronic devices having other image capture devices turned OFF. At 902, the portion of interest videoconference feed is selected from the one or more remote electronic devices having the image capture devices turned ON.

At 903, the selecting the portion of interest videoconference feed of 901 comprises selecting a videoconference feed from a remote electronic device associated with a previous videoconference feed redirected to the companion electronic device manually by an authorized user of the electronic device.

At 904, the method of 901 further comprises determining, by the one or more processors, a hierarchy of authorized users of each remote electronic device. At 904, the selecting the portion of interest videoconference feed comprises selecting an authorized user having a highest rank within the hierarchy.

At 905, the method of 901 further comprises analyzing, by the one or more processors, each videoconference feed from each remote electronic device for at least one depicted activity. At 905, the selecting the portion of interest videoconference feed comprises selecting a videoconference feed depicting more of the at least one depicted activity than other videoconference feed.

At 906, the at least one depicted activity of 905 comprises facial expressions made by participants of the videoconference. At 907, the at least one depicted activity of 905 comprises gestures made by participants of the videoconference. At 908, the at least one depicted activity of 905 comprises audible sounds enunciated by participants of the videoconference.

At 909, the method of 901 further comprises magnifying, by the one or more processors after the automatically redirecting the portion of interest videoconference feed to the another user interface of the companion electronic device, portions of the portion of interest videoconference feed in response to user input received by the another user interface of the companion electronic device.

At 910, the method of 901 further comprises presenting, by the one or more processors prior to the automatically redirecting the portion of interest videoconference feed to the another user interface of the companion electronic device, a prompt allowing the automatically redirecting the portion of interest videoconference feed to the companion electronic device. At 911, the prompt of 910 facilitates selection of another videoconference feed from the plurality of videoconference feeds to be redirected to the another user interface of the companion electronic device.

At 912, the electronic device comprises a communication device in communication with both a plurality of remote electronic devices during a videoconference and a content presentation companion device. At 912, the electronic device comprises a user interface and one or more processors operable with the communication device and the user interface.

At 912, the one or more processors are configured to analyze a plurality of videoconference feeds received by the communication device from the plurality of remote electronic devices during the videoconference to select a portion of interest videoconference feed. At 912, the one or more processors are thereafter configured to cause the communication device to automatically redirect the portion of interest videoconference feed to the content presentation companion device for presentation when the user interface is operating in an immersive mode.

At 913, the one or more processors of 912 are configured to select the portion of interest videoconference feed based upon at least one criterion of facial expressions, gestures, microphone input, past pinning preferences, participant hierarchy, and/or combinations thereof. At 914, the immersive mode of 912 comprises the user interface presenting content other than the plurality of videoconference feeds received from the plurality of remote electronic devices.

At 915, the one or more processors of 912 employ machine learning algorithms to select the portion of interest videoconference feed using real-time sentiment analysis of participant expressions to determine which participant is most expressive. At 916, the selection of the portion of interest videoconference feed is dynamically adjusted during the videoconference when the participant who is most expressive changes. At 916, the electronic device of 912 a computer and the content presentation companion device comprising a smartphone.

At 917, a non-transitory computer-readable storage medium comprises instructions that, when executed by a processor of a media device, cause the processor to perform operations comprising operating a user interface of the electronic device in an immersive mode during a videoconference. At 917, the instructions cause the processor to select a portion of interest videoconference feed as a function of predefined criteria including at least facial expressions, gestures, audible output, past pinning preferences, and/or participant hierarchy. At 917, the instructions cause the processor to automatically redirect the portion of interest videoconference feed to the content presentation companion device for presentation.

At 919, the instructions further cause the one or more processors to dynamically adjust selection of the portion of interest feed in real-time based on changes in activity or dynamics of the videoconference. At 920, the instructions cause the user interface to present content omitting depictions of videoconference participants when in the immersive mode.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device is a laptop computer equipped with a high-resolution display and a powerful processor capable of handling multiple videoconference feeds simultaneously. The content presentation companion device in this scenario could be a tablet, which is wirelessly connected to the laptop via a local network, allowing for seamless transfer of the portion of interest videoconference feed.

In another embodiment, the electronic device is a desktop computer with a dedicated graphics card to enhance video processing capabilities, and the companion device is a smartphone connected via Bluetooth, providing a portable solution for displaying the selected videoconference feed. The processors in this embodiment utilize machine learning algorithms to prioritize feeds based on real-time analysis of participant expressions and gestures.

Alternatively, the electronic device could be a smart TV with integrated videoconferencing software, where the companion device is a secondary monitor connected through an HDMI cable, offering a larger display area for the portion of interest feed. This setup could be particularly useful in a conference room setting, where the immersive mode on the smart TV allows for a full-screen presentation while the secondary monitor displays significant participant reactions. Each of these embodiments ensures that the system remains adaptable to various hardware configurations and user preferences, while maintaining the fundamental functionality of redirecting the most relevant videoconference feed to a companion device

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, with one or more processors during a videoconference when a user interface of the electronic device is operating in an immersive mode, that the electronic device is in communication both with at least one remote electronic device providing respective at least one videoconference feed and a companion electronic device;
automatically selecting, by the one or more processors, a portion of interest videoconference feed from the respective at least one videoconference feed; and
redirecting, by the one or more processors, the portion of interest videoconference feed to the companion electronic device for presentation by the companion electronic device.

2. The method of claim 1, wherein the at least one remote electronic device comprises one or more remote electronic devices having image capture devices turned ON and one or more other remote electronic devices having other image capture devices turned OFF, wherein the portion of interest videoconference feed is selected from the one or more remote electronic devices having the image capture devices turned ON.

3. The method of claim 1, wherein the selecting the portion of interest videoconference feed comprises selecting a videoconference feed from a remote electronic device associated with a previous videoconference feed redirected to the companion electronic device manually by an authorized user of the electronic device.

4. The method of claim 1, further comprising:
determining, by the one or more processors, a hierarchy of authorized users of each remote electronic device;
wherein the selecting the portion of interest videoconference feed comprises selecting an authorized user having a highest rank within the hierarchy.

5. The method of claim 1, further comprising:
analyzing, by the one or more processors, each videoconference feed from each remote electronic device for at least one depicted activity;
wherein the selecting the portion of interest videoconference feed comprises selecting a videoconference feed depicting more of the at least one depicted activity than other videoconference feed.

6. The method of claim 5, wherein the at least one depicted activity comprises facial expressions made by participants of the videoconference.

7. The method of claim 5, wherein the at least one depicted activity comprises gestures made by participants of the videoconference.

8. The method of claim 5, wherein the at least one depicted activity comprises audible sounds enunciated by participants of the videoconference.

9. The method of claim 1, further comprising magnifying, by the one or more processors after the automatically redirecting the portion of interest videoconference feed to another user interface of the companion electronic device, portions of the portion of interest videoconference feed in response to user input received by the another user interface of the companion electronic device.

10. The method of claim 1, further comprising presenting, by the one or more processors prior to the automatically redirecting the portion of interest videoconference feed to another user interface of the companion electronic device, a prompt allowing the automatically redirecting the portion of interest videoconference feed to the companion electronic device.

11. The method of claim 10, wherein the prompt facilitates selection of another videoconference feed from the plurality of videoconference feeds to be redirected to the another user interface of the companion electronic device.

12. An electronic device, comprising:
a communication device in communication with both:
a plurality of remote electronic devices during a videoconference; and
a content presentation companion device;
a user interface; and
one or more processors operable with the communication device and the user interface;
wherein the one or more processors are configured to analyze a plurality of videoconference feeds received by the communication device from the plurality of remote electronic devices during the videoconference to select a portion of interest videoconference feed and, thereafter, cause the communication device to automatically redirect the portion of interest videoconference feed to the content presentation companion device for presentation when the user interface is operating in an immersive mode.

13. The electronic device of claim 12 wherein the one or more processors are configured to select the portion of interest videoconference feed based upon at least one criterion of facial expressions, gestures, microphone input, past pinning preferences, participant hierarchy, and/or combinations thereof.

14. The electronic device of claim 12, wherein the immersive mode comprises the user interface presenting content other than the plurality of videoconference feeds received from the plurality of remote electronic devices.

15. The electronic device of claim 12, wherein the one or more processors employ machine learning algorithms to select the portion of interest videoconference feed using real-time sentiment analysis of participant expressions to determine which participant is most expressive.

16. The electronic device of claim 15, wherein selection of the portion of interest videoconference feed is dynamically adjusted during the videoconference when the participant who is most expressive changes.

17. The electronic device of claim 12, wherein the electronic device comprises a computer and the content presentation companion device comprising a smartphone.

18. A non-transitory computer-readable storage medium comprising instructions that, when executed by a processor of a media device, cause the processor to perform operations comprising:
operating a user interface of an electronic device in an immersive mode during a videoconference;
selecting a portion of interest videoconference feed as a function of predefined criteria including at least facial expressions, gestures, audible output, past pinning preferences, and/or participant hierarchy; and
automatically redirecting the portion of interest videoconference feed to a companion device for presentation.

19. The non-transitory computer-readable storage medium of claim 18, the instructions further causing the one or more processors to dynamically adjust selection of the portion of interest feed in real-time based on changes in activity or dynamics of the videoconference.

20. The non-transitory computer-readable storage medium of claim 18, the instructions further causing the user interface to present content omitting depictions of videoconference participants when in the immersive mode.
